(19) United States
(12) Patent Application Publication
(10) Pub. No.: US 2026/0351912 A1
(43) Pub. Date: Nov. 5, 2026

(54) CONNECTOR ASSEMBLY

(71) Applicant: Rivian IP Holdings, LLC, Irvine, CA (US)

(72) Inventors: Ryan Michael NORRIS, Mission Viejo, CA (US); Atul Arun SONAWANE, Irvine, CA (US)

(21) Appl. No.: 19/197,861

(22) Filed: May 2, 2025

(51) Int. Cl. H01R 25/16; H01H 71/08; H01R 12/72; H01R 13/66

(52) U.S. Cl. CPC H01R 25/162; H01H 71/082; H01R 12/72; H01R 13/6683; H01R 2201/26

(57) ABSTRACT

A connector assembly can be provided to a contactor to facilitate electrical connections at one or more busbars connected to the contactor and to provide insulation at various regions across the contactor and/or the busbars. The connector assembly can further provide one or more sensors for monitoring conditions (e.g., temperature and/or voltage) of the contactor and/or the busbars. The connector assembly can further facilitate connections to other features (e.g., fuse and/or discharge port) for interfacing with the contactor and/or the busbars via the connector assembly.

### INTRODUCTION

Batteries are often used as a source of power, including as a source of power for electric vehicles that include wheels that are driven by an electric motor that receives power from the batteries. A battery may include several battery cells that are connected to each other and/or other electrical components of an electric vehicle.

Aspects of the subject technology can help to improve the durability and longevity of batteries of electric vehicles, which can help to mitigate climate change by reducing greenhouse gas emissions.

### SUMMARY

A connector assembly can be provided to a contactor to facilitate electrical connections at one or more busbars connected to the contactor and to provide insulation at various regions across the contactor and/or the busbars. The connector assembly can further provide one or more sensors for monitoring conditions (e.g., temperature and/or voltage) of the contactor and/or the busbars. The connector assembly can further facilitate connections to other features (e.g., fuse and/or discharge port for service drain) for interfacing with the contactor and/or the busbars via the connector assembly.

According to one or more implementations of the present disclosure, a connector assembly for a contactor is described. The connector assembly may include a first conductor including a first connector and a second connector; a second conductor including a third connector and a fourth connector; an insulating cover encapsulating a portion of the first conductor between the first connector and the second connector and a portion of the second conductor between the third connector and the fourth connector, the insulating cover defining a first opening exposing the second connector and a second opening exposing the fourth connector; and a printed circuit board connected to the second conductor.

The printed circuit board can include a voltage sensor. The printed circuit board can include a temperature sensor. The printed circuit board can include a communication interface configured to communicate with a system connected to the printed circuit board via the communication interface. The printed circuit board can be connected to a terminal end of the second conductor.

The first connector can define a first terminal end of the first conductor; the second connector can define a second terminal end of the first conductor; the third connector can define a first terminal end of the second conductor; and the fourth connector can define a portion of the second conductor between the first terminal end of the second conductor and a second terminal end of the second conductor. The second connector can be configured to receive a first engager for coupling the first conductor to a first main busbar and a contactor; and the fourth connector can be configured to receive a second engager for coupling the second conductor to a second main busbar and the contactor. The first conductor can be formed as a first connector busbar; and the second conductor can be formed as a second connector busbar. The first connector busbar and the second connector busbar are formed with a rigid, electrically conductive material; and the insulating cover can be formed with a rigid, electrically insulative material.

A system can include a connector assembly and a contactor. The contactor can include: a switched side electrically coupled to the first conductor of the connector assembly by a first main busbar, wherein the first conductor can be further connected to a fuse; and an unswitched side electrically coupled to the second conductor of the connector assembly by a second main busbar, wherein the second conductor can be further connected to a discharge port.

According to one or more implementations of the present disclosure, a connector assembly for a contactor is described. The connector assembly may include an insulating cover including: an upper portion defining one or more openings; and a wall extending from one or more edges of the upper portion on a first side of the upper portion; a first conductor disposed partially within the insulating cover, the first conductor defining a first connector extending beyond the insulating cover and a second connector exposed by the one or more openings; a second conductor disposed partially within the insulating cover, the second conductor defining a third connector extending beyond the insulating cover and a fourth connector exposed by the one or more openings; and a printed circuit board on a second side of the upper portion, the printed circuit board being connected to the second conductor.

The insulating cover can encapsulate a portion of the first conductor between the first connector and the second connector and a portion of the second conductor between the third connector and the fourth connector. The one or more openings can include: a first opening exposing the second connector; and a second opening exposing the fourth connector. The first connector and the second connector extend from the wall and away from the upper portion. The wall defines: a first opening for receiving a first main busbar; and a second opening for receiving a second main busbar.

According to one or more implementations of the present disclosure, a method of assembling a contactor assembly is described. The method may include covering a first main busbar and a second main busbar with a connector assembly that includes: a first conductor including a first connector and a second connector; a second conductor including a third connector and a fourth connector; and an insulating cover encapsulating a portion of the first conductor between the first connector and the second connector and a portion of the second conductor between the third connector and the fourth connector; connecting the first connector to a fuse; connecting the second connector to the first main busbar and a contactor; connecting the third connector to a discharge port; and connecting the fourth connector to the second main busbar and the contactor.

The connector assembly can include a printed circuit board connected to the second conductor, the method further comprising connecting the printed circuit board to a controller. The insulating cover defines a first opening exposing the second connector and a second opening exposing the fourth connector; connecting the second connector to the first main busbar and the contactor can include providing a first fastener at the first opening; and connecting the fourth connector to the second main busbar and the contactor can include providing a second fastener at the second opening. Connecting the second connector to the contactor can include connecting the second connector to an unswitched side of the contactor; and connecting the fourth connector to the contactor can include connecting the fourth connector to a switched side of the contactor.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a block diagram of an example of a contactor assembly, in accordance with one or more implementations of the present disclosure.

FIG. 2 illustrates a perspective view of a system including a contactor, in accordance with one or more implementations of the present disclosure.

FIG. 3 illustrates a perspective view of a connector assembly, in accordance with one or more implementations of the present disclosure.

FIG. 4 illustrates another perspective view of the connector assembly of FIG. 3, in accordance with one or more implementations of the present disclosure.

FIG. 5 illustrates a perspective view of the system of FIG. 2 with the connector assembly of FIGS. 3 and 4, in accordance with one or more implementations of the present disclosure.

FIG. 6 illustrates a flow diagram showing an example of a process that may be performed for assembling a connector assembly in accordance with one or more implementations of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

A connector assembly can be provided to a contactor to facilitate electrical connections at one or more busbars connected to the contactor and to provide insulation at various regions across the contactor and/or the busbars. The connector assembly can further provide one or more sensors for monitoring conditions (e.g., temperature and/or voltage) of the contactor and/or the busbars. The connector assembly can further facilitate connections to other features (e.g., fuse and/or discharge port for service drain) for interfacing with the contactor and/or the busbars via the connector assembly.

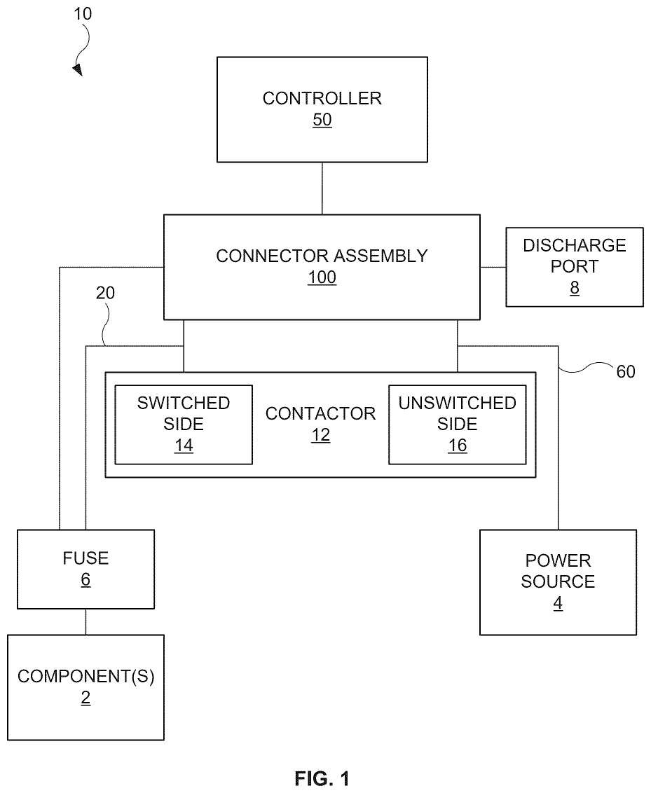

FIG. 1 illustrates a block diagram of an example of a contactor assembly 10, in accordance with one or more implementations of the present disclosure. The contactor assembly 10 can include a connector assembly 100 and a contactor 12. The connector assembly 100 can be mechanically and/or electrically connected to the contactor 12 by a first main busbar 20 and/or a second main busbar 60. The contactor 12 can include a switched side 14 (e.g., having a first terminal) and an unswitched side 16 (e.g., having a second terminal).

In some embodiments, the contactor assembly 10 is part of a moveable apparatus, such as a vehicle. The vehicle can include a power source 4, such as one or more battery packs. The power source 4 (e.g., one or more battery packs) may be coupled to one or more electrical systems, such as one or more components 2, of the vehicle via the contactor 12 to provide switched power to the electrical systems. In some embodiments, one or more fuses (not shown) can be provided between the switched side 14 of the contactor 12 and the one or more components 2. For example, as shown in FIG. 1, the one or more components 2 mechanically and/or electrically connected to the contactor 12 by one or more first main busbars 20 at the switched side 14, and the power source 4 can be mechanically and/or electrically connected to the contactor 12 by one or more second main busbars 60 at the unswitched side 16. In some embodiments, the contactor 12 can manage and provide switched power from the power source 4 to one or more electrical systems, such as the one or more components 2. The contactor 12 may include control circuitry that is operable to switchably couple the power between the power source 4 and the one or more components 2.

In some embodiments, as further shown in FIG. 1, the contactor assembly 10 can include a connector assembly 100 that mechanically and/or electrically connected to the contactor 12. For example, the connector assembly 100 can directly or indirectly connect to each of the one or more first main busbars 20 and the switched side 14 of the contactor assembly 10. The connector assembly 100 can further provide mechanical and/or electrical connections between a fuse 6 and the one or more first main busbars 20 and/or the switched side 14 of the contactor assembly 10. The connection to the fuse 6 can serve as an auxiliary connection thereto (e.g., where the fuse 6 also connects the switched side 14 of the contactor 12 to the one or more components 2). It should be recognized that the fuse 6 can be omitted and/or be connected to either one of the connector assembly 100 or the contactor 12. For example, fuse 6 can provide a connection between the first main busbar 20 and the one or more components 2, as well as a connection between the connector assembly 100 and the one or more components 2.

By further example, the connector assembly 100 can directly or indirectly connect to each of the one or more second main busbars 60 and the unswitched side 16 of the contactor assembly 10. The connector assembly 100 can further provide mechanical and/or electrical connections between a discharge port 8 and the one or more second main busbars 60 and/or the unswitched side 16 of the contactor assembly 10.

In some embodiments, the connector assembly 100 can directly or indirectly connect to a controller 50 for controlling one or more operations associated with the connector assembly. For example, the connector assembly 100 can provide one or more outputs (e.g., sensor data) that is received by the controller 50. For example, sensor data output by the connector assembly 100 can relate to the conditions at the contactor and/or one or more of the busbars. Such data can be received and applied by the controller 50 for further operations thereof.

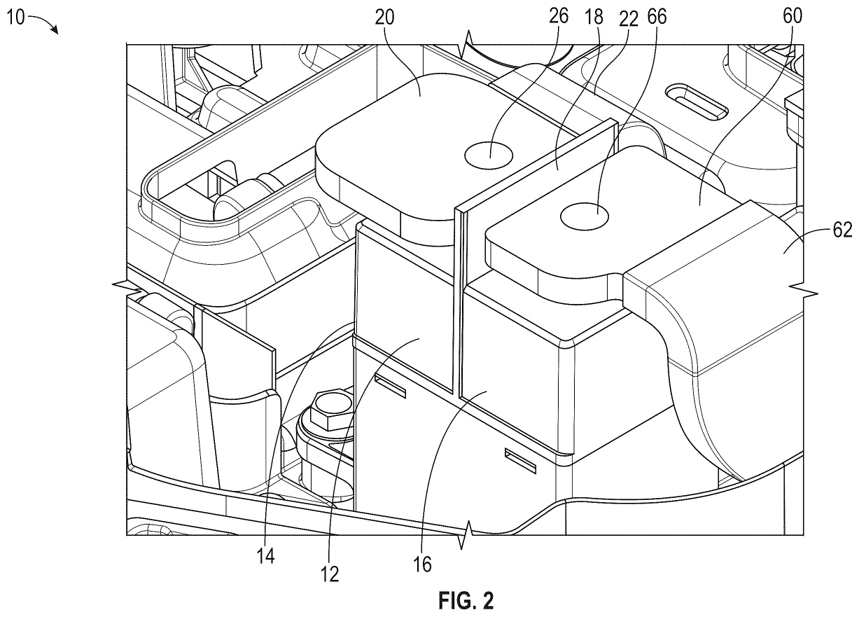

FIG. 2 illustrates a perspective view of a system including a contactor, in accordance with one or more implementations of the present disclosure. In some embodiments, as shown in FIG. 2, the contactor 12 can provide the switched side 14 and the unswitched side 16 on opposing sides of a wall 18. The wall 18 can separate the switched side 14 from the unswitched side 16 and/or provide an insulating layer for electrical isolation there between. The first main busbar 20 can be provided at the switched side 14 of the contactor 12, and the second main busbar 60 can be provided at the unswitched side 16 of the contactor 12. The first main busbar 20 can include a first main busbar engager 26 for facilitating engagement with the switched side 14 of the contactor 12 and/or a portion of a connector assembly, as described further below. The second main busbar 60 can include a second main busbar engager 66 for facilitating engagement with the unswitched side 16 of the contactor 12 and/or a portion of a connector assembly, as described further below. Such engagers can include one or more of a variety of components for facilitating mechanical and/or electrical connections between different parts. For example, the first main busbar engager 26 and/or the second main busbar engager 66 can include an opening, a thread, a pin, a snap, a clip, a fastener, a combination thereof, and the like.

In some embodiments, the first main busbar 20 can include a first cover 22 that provides an insulating layer and/or electrical isolation along a portion of the first main busbar 20, and the second main busbar 60 can include a second cover 62 that provides an insulating layer and/or electrical isolation along a portion of the second main busbar 60. The covers can extend along respective lengths while maintaining portions (e.g., terminal ends) of the respective main busbars exposed, for example to facilitate mechanical and/or electrical connection to a respective side of the contactor 12.

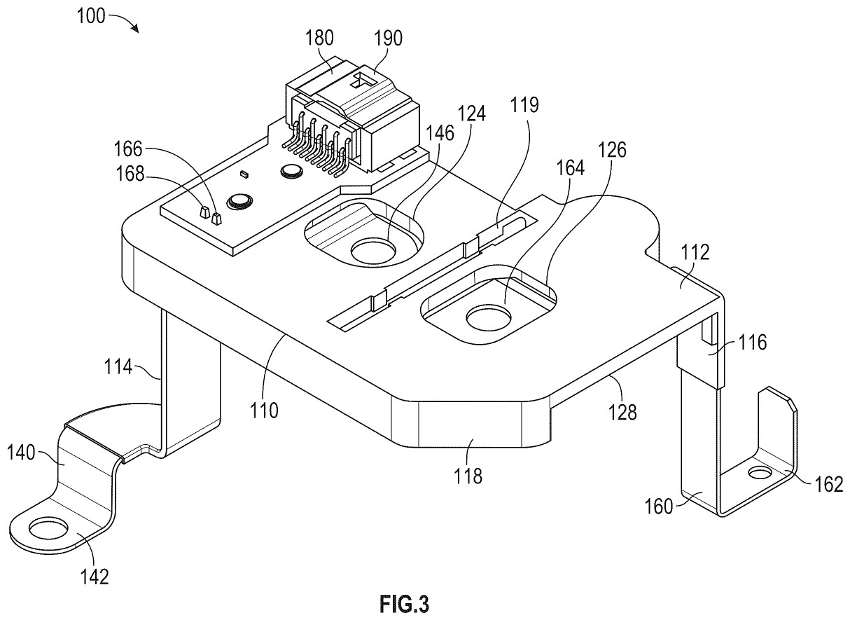

FIG. 3 illustrates a perspective view of a connector assembly, in accordance with one or more implementations of the present disclosure. In some embodiments, as shown in FIG. 3, the connector assembly 100 includes a first conductor 140 including a first connector 142 and a second connector 146. Each of the first connector 142 and the second connector 146 can define a terminal end or other portion (e.g., segment) of the first conductor 140. For example, the first conductor 140 can provide an electrically conductive path between the first connector 142 and the second connector 146. In some embodiments, the first connector 142 defines a first terminal end of the first conductor 140, and the second connector 146 defines a second terminal end of the first conductor 140. In some embodiments, the third connector 162 defines a first terminal end of the second conductor 160, and the fourth connector 164 defines a portion of the second conductor 160 between the first terminal end of the second conductor 160 and a second terminal end of the second conductor 160.

Each of the first connector 142 and the second connector 146 can define an engager for connecting to other components, such as a portion of the contactor and/or another component and/or connection. Such engagers can include one or more of a variety of components for facilitating mechanical and/or electrical connections between different parts. For example, the first connector 142 and the second connector 146 can include an opening, a thread, a pin, a snap, a clip, a fastener, a combination thereof, and the like.

In some embodiments, the connector assembly 100 includes a second conductor 160 including a third connector 162 and a second connector. Each of the third connector 162 and the fourth connector 164 can define a terminal end or other portion (e.g., segment) of the second conductor 160. For example, the second conductor 160 can provide an electrically conductive path between the third connector 162 and the fourth connector 164. Each of the third connector 162 and the fourth connector 164 can define an engager for connecting to other components, such as a portion of the contactor and/or another component and/or connection. Such engagers can include one or more of a variety of components for facilitating mechanical and/or electrical connections between different parts. For example, the third connector 162 and the fourth connector 164 can include an opening, a thread, a pin, a snap, a clip, a fastener, a combination thereof, and the like.

In some embodiments, the connector assembly 100 includes an insulating cover 110 encapsulating a portion of the first conductor 140 between the first connector 142 and the second connector 146. The insulating cover can also encapsulate a portion of the second conductor 160 between the third connector 162 and the fourth connector 164. The insulating cover can include an electrically insulative material. As such, the encapsulation can provide electrical isolation along portions of the respective conductors. To provide regions for mechanical and/or electrical connection with the respective conductors, the insulating cover 110 can define one or more openings there through, such as a first opening 124 exposing the second connector 146 and a second opening 126 exposing the fourth connector 164.

In some embodiments, as shown in FIG. 3, the insulating cover 110 includes an upper portion 112 defining the first opening 124 and/or the second opening 126. The insulating cover 110 can further define a wall 118 (e.g., a skirt, flange, or shelf) that extends from one or more edges of the upper portion 112 on a first side of the upper portion 112. The wall 118 can cover and partially surround structures placed under and/or within the connector assembly 100. The wall 118 can define one or more openings for receiving a busbar therein.

In some embodiments, as shown in FIG. 3, the insulating cover 110 includes portions extending along one or more conductors extending away from the upper portion 112 of the insulating cover 110. For example, a first extension 114 of the insulating cover 110 can extend along all sides along a length of the first conductor 140 that extends away from the upper portion 112 (e.g., between the first connector 142 and the second connector 146). As such, the first extension 114 can provide insulation and maintain electrical isolation of such a length of the first conductor 140 from an external environment while facilitating electrical conduction along the first conductor 140. By further example, a second extension 116 of the insulating cover 110 can extend along all sides along a length of the second conductor 160 that extends away from the upper portion 112 (e.g., between the third connector 162 and the fourth connector 164). As such, the second extension 116 can provide insulation and maintain electrical isolation of such a length of the second conductor 160 from an external environment while facilitating electrical conduction along the second conductor 160.

In some embodiments, the insulating cover 110 is formed as a monolithic structure, rather than an assembly of parts. For example, the monolithic structure can include the upper portion 112, the wall 118, the first extension 114, and/or the second extension 116. The monolithic structure can be formed about portions of the first conductor 140 and/or the second conductor 160 by one or more processes, such as injection molding. The monolithic structure can include a composition of a single material.

In some embodiments, the connector assembly 100 includes a printed circuit board 180 connected to the second conductor 160. The printed circuit board 180 can be connected to the second conductor 160 by one or more traces or other conductive structures that extend through a portion of the insulative cover 110 to reach the portion of the second conductor 160 therein. The printed circuit board 180 can include one or more electronic components that are operable to perform one or more functions. For example, the printed circuit board 180 can include a voltage sensor 169, a temperature sensor 168 (e.g., thermistor), and/or one or more other sensors. In some embodiments, the printed circuit board 180 includes a communication interface 190 configured to communicate with a controller (e.g., the controller of FIG. 1) that is connected to the printed circuit board 180 via the communication interface 190. The communication interface 190 can facilitate a connection based on an established design and/or protocol, such as a predefined jumper harness and/or a registered jack.

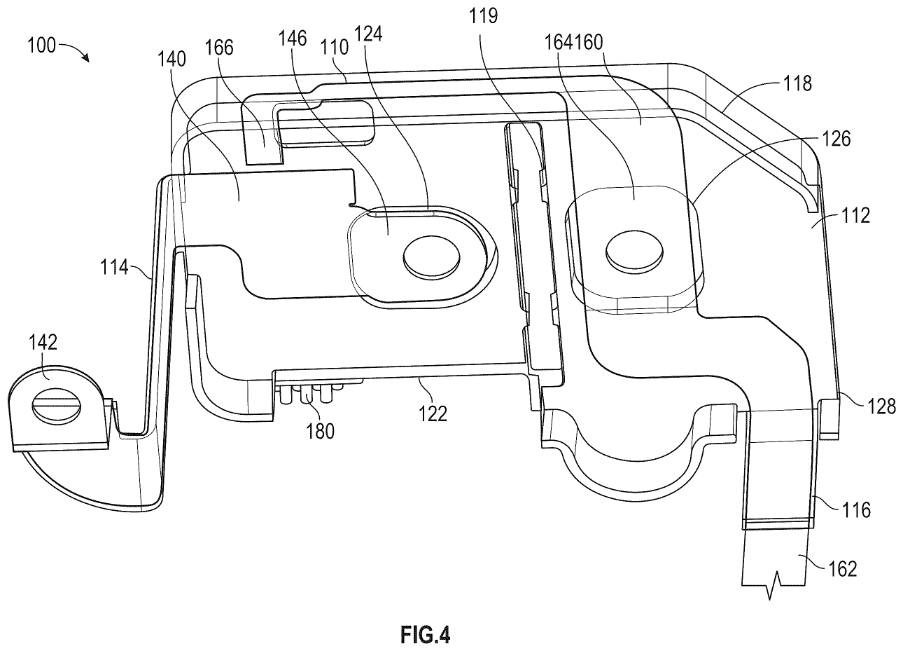

FIG. 4 illustrates another perspective view of the connector assembly of FIG. 3, in accordance with one or more implementations of the present disclosure. While the first conductor 140 and the second conductor 160 are visible at locations that align with the insulative cover 110 for illustrative purposes in FIG. 4, it will be understood that portions of the first conductor 140 can be encapsulated by the upper portion 112 and/or the first extension 114 of the insulative cover 110, and portions of the second conductor 160 can be encapsulated by the upper portion 112 and/or the second extension 116 of the insulative cover 110.

In some embodiments, as shown in FIG. 4, the printed circuit board 180 is connected to a terminal end 166 of the second conductor 160, which is connected to other portions of the second conductor 160, including the third connector 162 and the fourth connector 164, with the fourth connector 164 being between the terminal end 166 of the second conductor 160 and the third connector 162 of the second conductor 160.

In some embodiments, as shown in FIG. 4, the insulating cover 110 includes the upper portion 112 defining the first opening 124 and/or the second opening 126. To provide regions for mechanical and/or electrical connection with the respective conductors, the insulating cover 110 defines the first opening 124 for exposing the second connector 146 and the second opening 126 for exposing the fourth connector 164. One or more other portions of the first conductor 140 and/or the second conductor 160 can be encapsulated within the insulating cover 110. The wall 118 of the insulating cover 110 defines an interior space for receiving busbars and/or portions of the contractor. The wall 118 can define a first wall opening 122 for receiving a first main busbar therein and a second wall opening 128 for receiving a second main busbar therein. In some embodiments, as shown in FIG. 4, the insulating cover 110 defines an engagement opening 119 for receiving a wall of contactor, as described further herein.

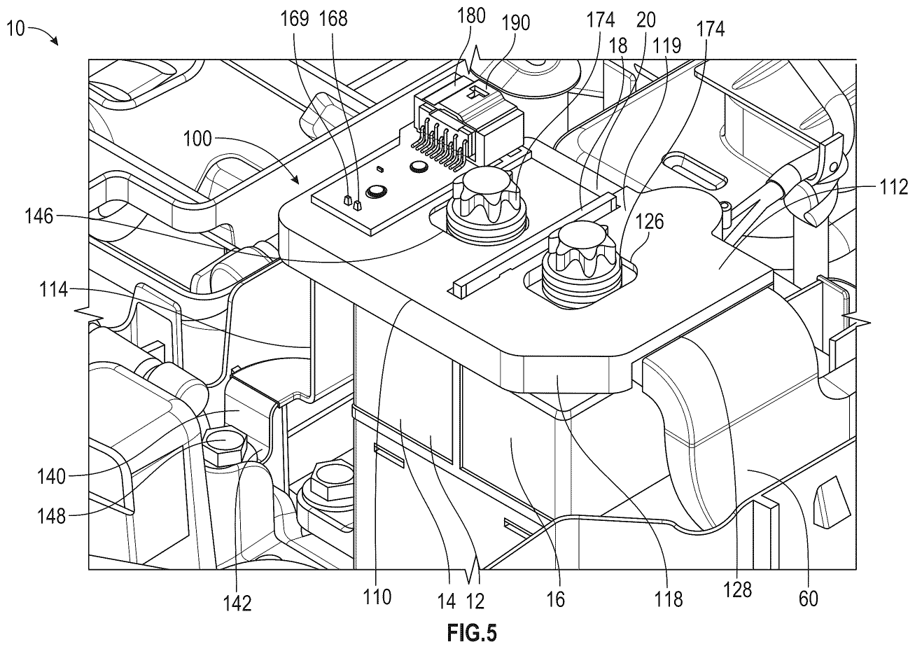

FIG. 5 illustrates a perspective view of the system of FIG. 2 with the connector assembly of FIGS. 3 and 4, in accordance with one or more implementations of the present disclosure. As shown in FIG. 5, the connector assembly 100 can be provided in an assembled configuration with the contactor 12, the first main busbar 20, and the second main busbar 60.

In some embodiments, the connector assembly 100 is provided with the first main busbar 20 extending through a first wall opening (not shown) in the insulative cover 110 of the connector assembly 100 and the second main busbar 60 extending through the second wall opening 128 in the insulative cover 110 of the connector assembly 100. The insulative cover 110 and the covers of the respective main busbars can form a substantially continuous protective layer between the conductive components and the external environment. As such, contact against the conductive components by items from the external environment can be avoided.

The first conductor 140 can be disposed partially within the insulating cover 110, the first conductor defining a first connector 142 extending beyond the insulating cover 110 and a second connector 146 exposed by the first opening 124. The second conductor 160 can be disposed partially within the insulating cover 110, the second conductor defining a third connector 162 extending beyond the insulating cover 110 and a fourth connector 164 exposed by the second opening 126.

In some embodiments, the wall 18 of the contactor 12 can be received within the engagement opening 119 of the insulating cover 110. Such engagement can provide alignment between the connector assembly 100 and the contactor 12. Furthermore, the wall 18 can provide electrical isolation between different electrical conductors, as described herein.

One or more engagers can be provided to achieve a secure engagement between the connector assembly, one or more busbars, and/or the contactor. In some embodiments, as shown in FIG. 5, a first fastener 174 can be provided to engage the first conductor 140, the first main busbar 20, and/or the switched side 14 of the contactor 12, for example at one or more respective engagers thereof. Such engagement can provide secure mechanical and/or electrical connections between the switched side 14 of the contactor, the first main busbar 20, and the first conductor 140 of the connector assembly 100. In some embodiments, as shown in FIG. 5, a second fastener 176 can be provided to engage the second conductor 160, the second main busbar 60, and/or the unswitched side 16 of the contactor 12, for example at one or more respective engagers thereof. Such engagement can provide secure mechanical and/or electrical connections between the unswitched side 16 of the contactor, the second main busbar 60, and the second conductor 160 of the connector assembly 100.

One or more engagers can be provided to achieve a secure engagement between the connector assembly and one or more other structures. For example, engagement can be provided with respect to other components of the system (e.g., a moveable apparatus such as a vehicle) into which the connector assembly is provided. In some embodiments, as shown in FIG. 5, a third fastener 148 can be provided (e.g., at the first connector 142) to engage the first conductor 140 and/or another structure (e.g., a terminal). Such engagement can provide secure mechanical and/or electrical connections between the first conductor 140 of the connector assembly 100 and another structure, which can connect to a controller, a fuse, and/or one or more electrical components. In some embodiments, a fourth fastener (not shown) can be provided to engage the second conductor (not shown) and/or another structure (e.g., a terminal). Such engagement can provide secure mechanical and/or electrical connections between the second conductor of the connector assembly 100 and another structure, which can connect to a discharge port and the like.

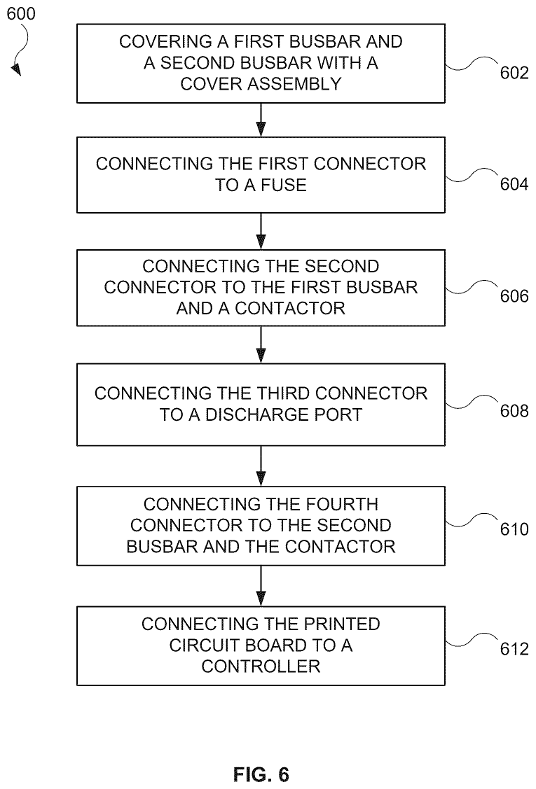

FIG. 6 illustrates a flow diagram showing an example of a process 600 that may be performed for forming a battery module in accordance with one or more implementations of the present disclosure. For explanatory purposes, the process 600 is primarily described herein with reference to components illustrated in FIG. 1-5. However, the process 600 is not limited to the components illustrated in FIG. 1-5, and one or more blocks (or operations) of the process 600 may be performed with one or more other components of other suitable apparatuses, devices, or systems. Further for explanatory purposes, some of the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

At block 602, a first main busbar and a second main busbar are covered with a connector assembly. The first main busbar and/or the second main busbar can be connected to and/or overlapping with a contactor. The connector assembly can include the features described herein. During the covering, the connector assembly can be aligned with the contactor, for example with complementary features that facilitate alignment.

At block 604, a first connector (e.g., of a first conductor) of the connector assembly can be connected to a fuse. The fuse can be connected to one or more electrical components. For example, the first connector can define a terminal end of a first conductor of the connector assembly, which can facilitate an electrical connection with a corresponding main busbar.

At block 606, a second connector (e.g., of a first conductor) of the connector assembly can be connected to a first main busbar and/or the contactor. Connecting the second connector to the first main busbar and/or the contactor can include providing a first fastener at a first engager (e.g., opening) of the first conductor.

At block 608, a third connector (e.g., of a second conductor) of the connector assembly can be connected to a discharge port. For example, the third connector can define a terminal end of a second conductor of the connector assembly, which can facilitate an electrical connection with a corresponding main busbar.

At block 610, a fourth connector (e.g., of a second conductor) of the connector assembly can be connected to a second main busbar and/or the contactor. Connecting the second connector to the second main busbar and/or the contactor can include providing a second fastener at a second engager (e.g., opening) of the second conductor.

At block 612, a printed circuit board of the connector assembly can be connected to a controller. The connector assembly can provide a connection between the printed circuit board and the second conductor.

Accordingly, aspects of the present disclosure provide a connector assembly that can be provided to a contactor to facilitate electrical connections at one or more busbars connected to the contactor and to provide insulation at various regions across the contactor and/or the busbars. The connector assembly can further provide one or more sensors for monitoring conditions (e.g., temperature and/or voltage) of the contactor and/or the busbars. The connector assembly can further facilitate connections to other features (e.g., fuse and/or discharge port for service drain) for interfacing with the contactor and/or the busbars via the connector assembly.

Aspects of the subject technology can help extend the life of a battery in a vehicle. This can help facilitate the functioning of and/or proliferation of batteries, which can positively impact the climate by reducing greenhouse gas emissions.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A connector assembly for a contactor, the connector assembly comprising:
a first conductor including a first connector and a second connector;
a second conductor including a third connector and a fourth connector;
an insulating cover encapsulating a portion of the first conductor between the first connector and the second connector and a portion of the second conductor between the third connector and the fourth connector, the insulating cover defining a first opening exposing the second connector and a second opening exposing the fourth connector; and
a printed circuit board connected to the second conductor.

2. The connector assembly of claim 1, wherein the printed circuit board includes a voltage sensor.

3. The connector assembly of claim 1, wherein the printed circuit board includes a temperature sensor.

4. The connector assembly of claim 1, wherein the printed circuit board includes a communication interface configured to communicate with a system connected to the printed circuit board via the communication interface.

5. The connector assembly of claim 1, wherein the printed circuit board is connected to a terminal end of the second conductor.

6. The connector assembly of claim 1, wherein:
the first connector defines a first terminal end of the first conductor;
the second connector defines a second terminal end of the first conductor;
the third connector defines a first terminal end of the second conductor; and
the fourth connector defines a portion of the second conductor between the first terminal end of the second conductor and a second terminal end of the second conductor.

7. The connector assembly of claim 1, wherein:
the second connector is configured to receive a first engager for coupling the first conductor to a first main busbar and a contactor; and
the fourth connector is configured to receive a second engager for coupling the second conductor to a second main busbar and the contactor.

8. The connector assembly of claim 1, wherein:
the first conductor is formed as a first connector busbar; and
the second conductor is formed as a second connector busbar.

9. The connector assembly of claim 8, wherein:
the first connector busbar and the second connector busbar are formed with a rigid, electrically conductive material; and
the insulating cover is formed with a rigid, electrically insulative material.

10. A contactor assembly comprising:
the connector assembly of claim 1; and
a contactor including:
a switched side electrically coupled to the first conductor of the connector assembly by a first main busbar, wherein the first conductor is further connected to a fuse; and
an unswitched side electrically coupled to the second conductor of the connector assembly by a second main busbar, wherein the second conductor is further connected to a discharge port.

11. A connector assembly for a contactor, the connector assembly comprising:
an insulating cover including:
an upper portion defining one or more openings; and
a wall extending from one or more edges of the upper portion on a first side of the upper portion;
a first conductor disposed partially within the insulating cover, the first conductor defining a first connector extending beyond the insulating cover and a second connector exposed by the one or more openings;
a second conductor disposed partially within the insulating cover, the second conductor defining a third connector extending beyond the insulating cover and a fourth connector exposed by the one or more openings; and
a printed circuit board on a second side of the upper portion, the printed circuit board being connected to the second conductor.

12. The connector assembly of claim 11, wherein the insulating cover encapsulates a portion of the first conductor between the first connector and the second connector and a portion of the second conductor between the third connector and the fourth connector.

13. The connector assembly of claim 11, wherein the one or more openings includes:
a first opening exposing the second connector; and
a second opening exposing the fourth connector.

14. The connector assembly of claim 11, wherein the first connector and the second connector extend from the wall and away from the upper portion.

15. The connector assembly of claim 11, wherein the wall defines:
a first opening for receiving a first main busbar; and
a second opening for receiving a second main busbar.

16. A contactor assembly comprising:
the connector assembly of claim 11; and
a contactor including:
a switched side electrically coupled to the first conductor of the connector assembly by a first main busbar, wherein the first conductor is further connected to a fuse; and
an unswitched side electrically coupled to the second conductor of the connector assembly by a second main busbar, wherein the second conductor is further connected to a discharge port.

17. A method of assembling a contactor assembly, the method comprising:
covering a first main busbar and a second main busbar with a connector assembly that includes:
a first conductor including a first connector and a second connector;
a second conductor including a third connector and a fourth connector; and
an insulating cover encapsulating a portion of the first conductor between the first connector and the second connector and a portion of the second conductor between the third connector and the fourth connector;
connecting the first connector to a fuse;
connecting the second connector to the first main busbar and a contactor;
connecting the third connector to a discharge port; and
connecting the fourth connector to the second main busbar and the contactor.

18. The method of claim 17, wherein the connector assembly includes a printed circuit board connected to the second conductor, the method further comprising connecting the printed circuit board to a controller.

19. The method of claim 17, wherein:
the insulating cover defines a first opening exposing the second connector and a second opening exposing the fourth connector;
connecting the second connector to the first main busbar and the contactor includes providing a first fastener at the first opening; and
connecting the fourth connector to the second main busbar and the contactor includes providing a second fastener at the second opening.

20. The method of claim 17, wherein:
connecting the second connector to the contactor includes connecting the second connector to an unswitched side of the contactor; and
connecting the fourth connector to the contactor includes connecting the fourth connector to a switched side of the contactor.
